(19) United States
(12) Patent Application Publication
(10) Pub. No.: US 2026/0055322 A1
(43) Pub. Date: Feb. 26, 2026

(54) Chemical Recycling of Artificial Turf

(71) Applicant: ExxonMobil Chemical Patents Inc., Baytown, TX (US)

(72) Inventors: Saurabh S. Maduskar, Houston, TX (US); Stephanie M. Westbrook, Brussels (BE); Wim Rubens, Temse (BE); Rainer Kolb, Kingwood, TX (US)

(21) Appl. No.: 19/104,510

(22) PCT Filed: Aug. 11, 2023
(86) PCT No.: PCT/US2023/072083

§ 371 Date: Feb. 18, 2025

Related U.S. Application Data
(60) Provisional application No. 63/403,377, filed on Sep. 2, 2022.

(51) Int. Cl. C10B 53/07; B29B 17/02; B29B 17/04; C10B 55/10

(52) U.S. Cl. CPC C10B 53/07; B29B 17/02; B29B 17/0412; C10B 55/10

(57) ABSTRACT

Systems and methods are provided for chemical recycling of artificial turf, including, in one embodiment, a method comprising: providing a turf feed comprising a sized carpet composition; and cracking at least the turf feed to produce at least a cracking product comprising hydrocarbons.

### CROSS REFERENCE TO RELATED APPLICATIONS

This application claims the benefit of and priority to U.S. Provisional Application No. 63/403,377 filed Sep. 2, 2022, the disclosure of which is incorporated herein by reference.

### FIELD

Systems and methods are provided for chemical recycling of artificial turf.

### BACKGROUND

Artificial turf is used as ground cover in a number of applications, including sports fields, playgrounds, and residential and commercial ground cover, among others. The artificial turf generally includes a carpet portion, one or more backing materials, one or more infill materials, and an optional shock pad. The carpet portion includes vertical fibers or upstanding ribbons that resemble blades of the artificial turf and often is made from thermoplastic materials. The fibers of the carpet portion will be referred to herein as “turf fibers.” The one or more backing materials can include a primary backing material and a secondary backing material. Among other materials, the primary backing material may include a thermoplastic, such as polypropylene, and the secondary backing material may include a polyurethane or latex, among others. The one or more infill materials simulates the soil in natural turf and can include an inorganic filler, such as sand. The one or more infill materials can also include a second infill material, such as granulated thermoset rubbers. The artificial turf optionally includes a shock pad underneath the backing materials.

While artificial turf is a suitable substitute for natural turf, it has a limited-service life and is often removed and replaced with a new turf material. Due to the large amount of artificial turf currently in service, there is a need to reuse and/or recycle some or all of the turf components. However, the options for turf recycling are limited. Mechanical recycling is difficult due to the composite nature of the artificial turf, typically including a thermoplastic component (e.g., turf fibers, primary backing material, etc.) and a thermoset component (e.g., secondary backing material). These mixtures are known to yield low value in mechanical recycling. Furthermore, because the artificial turf typically includes an inorganic filler as infill material, contamination of the turf fibers with this inorganic filler makes conventional mechanical recycling processes for carpets unsuitable. In addition, thermoset rubbers are also known to be difficult to recycle mechanically, especially if contaminated with inorganic filler material. Because the artificial turf further can include thermoset rubbers as a second infill material, mechanical recycling is further complicated.

### SUMMARY

Disclosed herein is an example A method of chemical recycling artificial turf, comprising: providing a turf feed comprising a sized carpet composition; and cracking at least the turf feed to produce at least a cracking product comprising hydrocarbons.

Further disclosed herein is an example method of chemical recycling artificial turf, comprising: providing a turf feed comprising an infill material from the artificial turf, wherein the infill material comprises a polymeric material; and cracking the turf feed to produce at least a cracking product comprising hydrocarbons.

These and other features and attributes of the disclosed methods and systems of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings, wherein:

FIG. 1 is an illustrative depiction of an artificial turf in accordance with certain embodiments of the present disclosure.

FIG. 2 is an illustrative depiction of a process for separating and sizing of an artificial turf in accordance with certain embodiments of the present disclosure.

FIG. 3 is an illustrative depiction of another process for separating and sizing of an artificial turf in accordance with certain embodiments of the present disclosure.

FIG. 4 is an illustrative depiction of a fluidized bed coking system including a coker, a heater, and a gasifier in accordance with certain embodiments of the present disclosure.

FIG. 5 is an illustrative depiction of a fluidized bed coking system including a coker and a gasifier in accordance with certain embodiments of the present disclosure.

FIG. 6 is an illustrative depiction of a delayed coking system including a coker and a gasifier in accordance with certain embodiments of the present disclosure.

FIG. 7 is a chart showing a mass loss profile from thermogravimetric analysis of a sample turf feed in accordance with certain embodiments of the present disclosure.

### DETAILED DESCRIPTION

In various embodiments, systems and methods are provided for chemical recycling of artificial turf. In some embodiments, a process for chemical recycling of artificial turf includes cracking a turf feed to produce hydrocarbons. In some embodiments, the turf feed is co-processed in the cracking environment with a conventional cracking feed stock, such as petroleum vacuum residuum. While the systems and methods disclosed herein are suitable for cracking the turf feed in a variety of different cracking embodiments, they may be particularly suitable for cracking the turf feed in a coking environment, such as delayed coking and fluidizing coking environments.

The chemical recycling of artificial turf by way of cracking can be performed, for example, by performing several processes on the artificial turf. First, the artificial turf can be conditioned to provide a turf feed. The turf feed includes one or more components of the artificial turf, including sized turf fibers, sized primary backing material, and sized secondary backing material. The turf feed can also include at least a portion of the infill material, such a first infill material of an inorganic filler or a second infill material of a thermoset rubber. Second, the turf feed can be passed into a hydrolysis environment, such as a fluidized coking environment or a delayed coking environment. The turf feed can be passed into the hydrolysis environment as a separate stream or in a slurry, for example, with a carrier fluid and/or a conventional cracking feedstock. Third, the turf feed can then be processed in the cracking environment to generate cracking products. The cracking products generated are valuable products for further processing, for example, gases, naphtha, gas oils, and/or coke. In some embodiments, the turf feed is co-processed in the processes in the cracking environment with one or more co-feeds, such as a conventional cracking feedstock.

In some embodiments, the chemical recycling of the artificial turf by way of cracking provides advantages relative to mechanical processing. As previously noted, mechanical processing of artificial turf is challenging due to its complex nature of many different materials, such as thermoset materials, thermoplastic materials, rubber granules, and/or inorganic fillers. Advantageously, example embodiments provide a technique for chemical recycling of artificial turf while producing desirable products. Since the chemical composition of artificial turf is chemically compatible with a cracking environment (e.g., coking), the turf is processed in the cracking environment to produce desirable products, such as gases, naphtha, gas oils, and/or coke. In addition, when processed in a coking environment, in accordance with one or more embodiments, the inorganic filler in the coke feed is segregated into the coke, thus allowing for recycling of turf feeds contaminated with the inorganic filler that would otherwise be problematic to recycle. By handling the inorganic filler in the chemical recycling, example embodiments address a key problem with recycling of the artificial turf.

While artificial turf is a suitable substitute for natural turf, it has a limited-service life and is often removed and replaced with a new turf material. Due to the large amount of artificial turf currently in service, there is a need to reuse and/or recycle some or all of the turf components. However, the options for turf recycling are limited. Mechanical recycling is difficult due to the composite nature of the artificial turf, typically including a thermoplastic component (e.g., turf fibers, primary backing material, etc.) and a thermoset component (e.g., secondary backing material). These mixtures are known to yield low value in mechanical recycling. Furthermore, because the artificial turf typically includes an inorganic filler as infill material, contamination of the turf fibers with this inorganic filler makes conventional mechanical recycling processes for carpets unsuitable. In addition, thermoset rubbers are also known to be difficult to recycle mechanically, especially if contaminated with inorganic filler material. Because the artificial turf further can include thermoset rubbers as a second infill material, mechanical recycling is further complicated.

### Artificial Turf

Artificial turf is used as ground cover in a number of applications, including sports fields, playgrounds, and residential and commercial ground cover, among others. Artificial turf generally includes a number of components, including turf fibers, a primary backing material, a secondary backing material, an infill material, and/or a shock pad. In some embodiments, the turf fibers are coupled to the primary backing material and extend upward from a top side of the primary backing material resembling blades of grass. In some embodiments, the infill material is dispersed between the turf fibers extending from the primary backing material. In some embodiments, the second backing material is coupled to a bottom side of the primary backing material to hold the turf fibers on the primary backing material. Artificial turf also includes the optional shock pad beneath the secondary backing material.

The turf fibers include any material suitable for use in manufacture of the artificial turf. Examples of suitable materials for the turf fibers include thermoplastic materials, such as polyolefins, polyesters, polyamides, or other suitable thermoplastics and blends thereof. In some embodiments, the turf fibers include polyethylene, polypropylene, polyamide 6, polyamide 6,6, polyethylene terephthalate, or combinations thereof.

In some embodiments, the turf fibers are coupled to the primary backing material. The turf fibers can be coupled to the primary backing material through any suitable means. For example, the turf fibers are tufted or sewn into the primary backing material. By way of further example, adhesives may be used for securing the turf fibers. In some embodiments, the primary backing material includes one or more thermoplastic materials. Examples of suitable thermoplastic materials for the primary backing material include polyolefins, polyamides and polyesters. In some embodiments, the primary backing material includes polyethylene, polypropylene, polyamides, polyethylene terephthalate, or combinations thereof.

In some embodiments, the artificial turf further includes the secondary backing material. The secondary backing material is coupled to a bottom side of the primary backing material to hold the turf fibers on the primary backing material. In some embodiments, the secondary backing material is coated onto the bottom side of the primary backing material. Examples of suitable secondary backing materials includes thermoset materials. In some embodiments, the secondary backing material includes polyurethane, a thermoset elastomer (e.g., natural or synthetic rubber latex), an acrylic adhesive, or combinations thereof.

In some embodiments, the artificial turf further includes an infill material. The infill material is dispersed between the turf fibers, for example, to function as a ballast. The infill material may include a single infill material or a combination of infill materials. In some embodiments, the infill material includes a first infill material and a second infill material. Examples of suitable first infill materials include inorganic materials, such as sand, gravel, or other inorganic materials. Examples of suitable second infill materials include cork and polymeric materials, such as polymer beads, thermoset rubbers, thermoplastic elastomers, thermoplastic vulcanizates, thermoplastic materials, and combinations thereof. In some embodiments, the second infill material includes ground tire rubber, crumb rubber, styrene-butadiene rubber, polybutadiene rubber, ethylene propylene diene methylene (EPDM) rubber, neoprene rubber, and combinations thereof. In some embodiments, combinations of suitable infill materials are used.

In some embodiments, the artificial turf further includes a shock pad. Where used, the shock pad is placed, for example, underneath the secondary backing material. The shock pad functions as a shock absorbing material. In some embodiments, the shock pad includes polyurethane, polyvinyl chloride foam plastic, polyurethane foam, a rubber, a closed-cell crosslinked polyethylene foam, a polyurethane underpad having voids, elastomer foams of polyvinyl chloride, polyethylene, polyurethane and polypropylene, and combinations thereof.

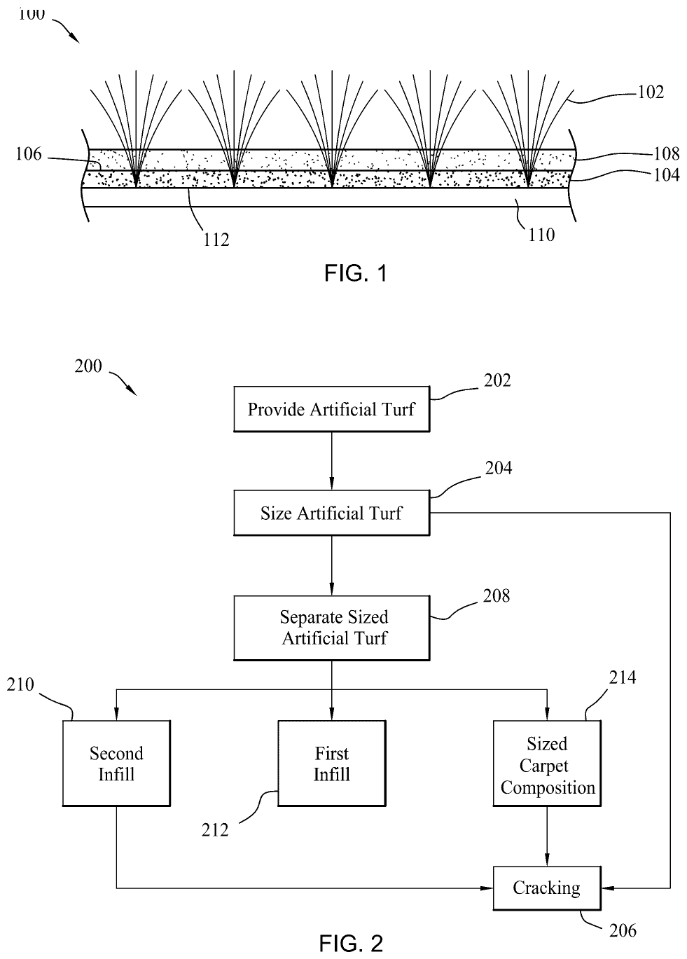

FIG. 1 illustrates a cross-sectional view of an artificial turf 100 in accordance with one or more embodiments. In the illustrated embodiment, the artificial turf 100 includes turf fibers 102 coupled to a primary backing material 104. The turf fibers 102 extends from a top side 106 of the primary backing material 104 with an infill material 108 dispersed between the turf fibers 102. A second backing material 110 is coupled to a bottom side 112 of the primary backing material 104. While not shown, the artificial turf 100 may include an optional shock pad underneath the second backing material 110.

### Artificial Turf Conditionings

Example embodiments include conditioning of the artificial turf into a turf feed. In some embodiments, the turf feed includes a carpet composition, for example, the artificial turf with separation of at least a portion of the infill materials. The artificial turf can be obtained from a number of sources. In some embodiments, the artificial turf is obtained from a collection site after its removal from a field or other installation location. The collection site includes post-consumer artificial turf suitable for conditioning into a turf feed. In some embodiments, the artificial turf is sorted based on type of turf fibers. In some embodiments, the artificial turf is baled.

Conditioning of the artificial turf includes performing a physical processing step on the artificial turf to prepare it for a cracking environment. In some embodiments, conditioning includes sizing of the artificial turf to reduce its particle size. For example, having a small particle size can facilitate transport of the solids and/or reduce the likelihood of incomplete conversion in cracking. Examples of physical processing can include sizing of the artificial turf, for example, by crushing, chopping, shredding, and grinding (including cryogenic grinding). In some embodiments, the physical processing can be used to reduce the median particle size of to 0.01 millimeters (“mm”) to 50 mm, 0.1 to 50 mm, 0.1 to 30 mm, 0.1 to 20 mm, 5.0 mm, or 0.1 mm to 5.0 mm, or 0.01 mm to 3.0 mm, or 0.1 mm to 3.0 mm, or 0.01 mm to 3.0 mm, or 0.1 mm to 3.0 mm, or 1.0 mm to 5.0 mm, or 1.0 mm to 3.0 mm. to reduce the maximum particle size. For determining a median particle size, the particle size is defined as the diameter of the smallest bounding sphere that contains the particle. Optionally, after the physical processing, the thermoset resin can be sieved or filtered to remove larger particles. In some embodiments, the sieving or filtering can be used to reduce the maximum particle size to 10 mm or less, or 5.0 mm or less.

In some embodiments, a turf feed for cracking includes a sized artificial turf without any additional separation. In other embodiments, the sized artificial turf is separated into one or more components to provide a turf feed. The components may be separated, for example, by specific gravity, size, and/or shape. Examples of suitable separation techniques include sieving, specific sieving by specific gravity, and/or separation by air swirling (e.g., cyclone separators). Different fractions of the sized artificial turf may be obtained that contain or more different components of the artificial turf. Polymeric turf components are suitable for chemical recycling by way of cracking, in accordance with one or more embodiments. It should be understood that certain components (such as sand) would not be converted but instead partition with the coke. The turf feed may include, for example, one or more of sized turf fibers, sized primary backing material, sized secondary backing material, first infill material, second infill material, and/or sized shock pad. Even though it may be desired to separate the turf fibers from the artificial turf to provide a turf feed of only turf fibers, the turf fibers may be contaminated with other components of the artificial turf so that the separate turf fibers further include additional components, such as primary backing material, secondary backing material, first infill material, second infill material, and/or shock pad. In some embodiment, the infill materials are separated from the other turf components to form a carpet composition for the turf feed, wherein the carpet composition comprises one or more of the turf fibers, primary backing material, secondary backing material, and/or shock pad. It should be understood that, while it may be desirable to separate the carpet composition from the infill materials for recycling the carpet composition may be contaminated with the infill materials, such as the first infill material of the to provide a turf feed of the inorganic filler.

FIG. 2 illustrates a process 200 for conditioning artificial turf. As illustrated, the process 200 includes providing an artificial turf, as shown at block 202. The artificial turf is then sized at block 204 to provide sized artificial turf. As previously described, any suitable technique may be used to size the artificial turf to provide a sized artificial turf with a reduced particle size, including crushing, chopping, cutting, shredding, and grinding. In some embodiments, the sized artificial turf is used as a turf feed for cracking, as shown in block 206 without further separation. The sized artificial turf may be pyrolyzed separately, in combination with one or more turf fractions, or with a conventional cracking feedstock. In some embodiments, the sized artificial turf is separated into one or more fractions, as shown in block 206. For example, the infill material is separated from the sized carpet composition to provide at least separated second infill material at bock 210, separated first infill material (e.g., shown as separated inorganic filler at block 212, and sized composition at block 214. The sized carpet composition at block 214 may include one or more of turf fibers, primary backing material, secondary backing material, and/or shock pad. In some embodiments, the sized carpet composition may also be separated into different fractions, such as a turf fiber fraction, a primary backing fraction, and/or a secondary backing fraction. As illustrated, example embodiments include cracking of the sized carpet composition and/or second infill material at block 206, which may be cracked separately, in combination with one another, or in combination with a conventional cracking feedstock.

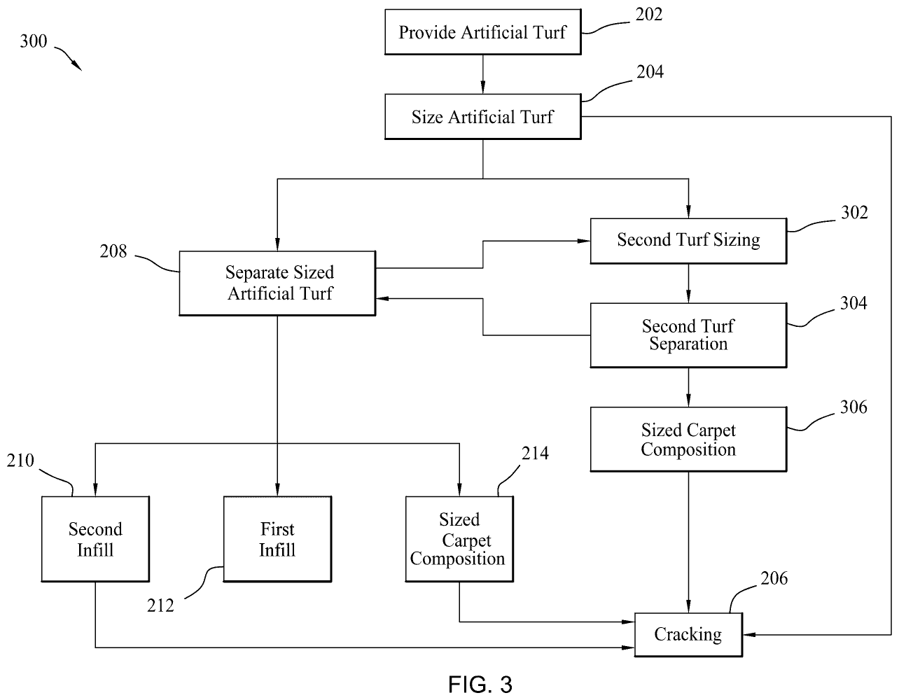

FIG. 3 illustrates a process 300 for conditioning artificial turf. As illustrated, the process 300 includes providing an artificial turf, as shown at block 202. The artificial turf is then sized at block 204 to provide sized artificial turf. As previously described, any suitable technique may be used to size the artificial turf to provide a sized artificial turf with a reduced particle size, including crushing, chopping, shredding, and grinding. In some embodiments, the sized artificial turf is used as a turf feed for cracking, as shown in block 206 without further separation. The sized artificial turf may be pyrolyzed separately, in combination with one or more turf fractions, or with a conventional cracking feedstock. In some embodiments, the sized artificial turf is separated into one or more fractions, as shown in block 206. For example, the infill material is separated from the sized carpet composition to provide at least separated second infill material at bock 210, separated first infill material (e.g., shown as separated inorganic filler at block 212, and sized carpet composition at block 214. The sized carpet composition at block 214 may include one or more of turf fibers, primary backing material, secondary backing material, and/or shock pad. In some embodiments, the sized carpet composition may also be separated into different fractions, such as a turf fiber fraction, a primary backing fraction, and/or a secondary backing fraction. As illustrated, example embodiments include cracking of the sized carpet composition and/or separated second infill material at block 206, which may be cracked separately, in combination with one another, or in combination with a conventional cracking feedstock.

In some embodiments, the sized artificial turf from block 204 is provided to a second turf sizing at block 302 for further size reduction. In some embodiments, the sized carpet composition separated in block 208 is provided to the second turf sizing at block 302 for further size reduction. The output of block 302 with further size reduction is provided to a second turf separation, at block 304, in accordance with present embodiments. In the second turf separation of block 304, the first infill material (e.g., inorganic filler) may be separated from the sized turf composition to provide a turf composition, at block 306, which may then be cracked at block 206. The separated first infill material from block 304 is optionally returned to the separating of block 208.

### Cracking Feed

In accordance with present embodiments, a turf feed is pyrolyzed to produce hydrocarbons. In some embodiments, the turf feed is co-pyrolyzed with a conventional cracking feed. The turf feed includes one or more components of an artificial turf. For example, the turf feed includes a sized carpet composition including one or more of turf fibers, primary backing material, secondary backing material, and/or sized backing pad. In some embodiments, the carpet composition is contaminated with an infill material such that the turf feed further comprises an infill material, for example, the first infill material of the inorganic material.

In some embodiments, the sized carpet composition is included in the turf feed in any suitable amount. For example, the sized carpet composition may be included in the turf feed in an amount of 0.10% to 100% by weight of the turf feed. In some embodiments, the sized carpet composition is included in the turf feed in an amount 1% to 99%, 1% to 95%, 1% to 90%, 1% to 50%, 10% to 100%, 10% to 90%, 10% to 50%, 40% to 100%, 40% to 90%, 50% to 100%, or 50% to 90% by weight of the turf feed.

In some embodiments, the sized turf fibers are included in the carpet composition in any suitable amount. For example, the sized turf fibers may be included in the carpet composition in an amount of 0.1% to 100% by weight of the carpet composition. In some embodiments, the sized turf fibers are included in the carpet composition in an amount 1% to 99%, 1% to 95%, 1% to 90%, 1% to 50%, 10% to 100%, 10% to 90%, 10% to 50%, 40% to 100%, 40% to 90%, 50% to 100%, or 50% to 90% by weight of the carpet composition.

In some embodiments, sized primary backing material is included in the carpet composition. For example, the sized primary backing material may be included in the carpet composition in an amount of 0.10% to 100% by weight of the turf feed. In some embodiments, the sized primary backing material is included in the carpet composition in an amount of 1% to 100%, 1% to 95%, 1% to 90%, 1% to 80%, 1% to 50%, 1% to 20%, or 1% to 75%, 1% to 50%, 10% to 20%, 10% to 100%, 10% to 50% by weight of the carpet composition.

In some embodiments, sized secondary backing material is included in the carpet composition. For example, the sized secondary backing material may be included in the carpet composition in an amount of 0.1% to 100% by weight of the carpet composition. In some embodiments, the sized secondary backing material is included in the carpet composition in an amount of 1% to 100%, 1% to 95%, 1% to 90%, 1% to 80%, 1% to 50%, 1% to 20%, or 1% to 75%, 1% to 50%, 10% to 20%, 10% to 100%, 10% to 50% by weight of the carpet composition.

In some embodiments, a sized backing pad is included in the carpet composition. For example, the sized backing pad may be included in the carpet composition in an amount of 0.1% to 100% by weight of the carpet composition. In some embodiments, the sized backing pad is included in the carpet composition in an amount of 1% to 100%, 1% to 95%, 1% to 90%, 1% to 80%, 1% to 50%, 1% to 20%, or 1% to 75%, 1% to 50%, 10% to 20%, 10% to 100%, 10% to 50% by weight of the carpet composition.

In some embodiments, the infill materials are included in the turf feed. The infill material includes a first infill material (e.g., an inorganic filler) and/or a second infill material (e.g., thermoset rubbers, thermoset elastomers, etc.). Where present, the infill materials may be included in the turf feed in an amount of 0.1% to 100% by weight of the turf feed. In some embodiments, the infill materials are included in the turf feed in an amount of 1% to 100%, 1% to 95%, 1% to 90%, 1% to 80%, 1% to 50%, 1% to 20%, or 1% to 75%, 1% to 50%, 10% to 20%, 10% to 100%, 10% to 50% by weight of the turf feed. In some embodiments, it may be desirable to limit the amount of the first infill material of an inorganic filler in the turf feed. For example, the first infill material may be present in the turf feed in an amount of 50% or less by weight of the turf feed. In some embodiments, the first infill material is present in the turf feed in an amount of 40%, 30%, 20%, 15%, 10%, or less by weight of the turf feed. For example, the first turf infill may be present in an amount of about 0.10% to about 40%, about 0.1% to about 30%, about 0.1% to about 20%, about 0.1% to about 15%, about 0.1% to about 10%, about 0.1% to about 5%, about 1% to about 20%, about 1% to about 10%, about 1% to about 5%, or about 1% to about 3% by weight of the turf feed. In some embodiments, the second infill may be present in the turf feed in an amount of 0.1% to 100% by weight of the turf feed. In some embodiments, the second infill material is included in the turf feed in an amount of 1% to 100%, 1% to 95%, 1% to 90%, 1% to 80%, 1% to 50%, 1% to 20%, or 1% to 75%, 1% to 50%, 10% to 20%, 10% to 100%, 10% to 50% by weight of the turf feed.

In some embodiments, the turf feed includes a sized carpet composition and an infill material, wherein the sized carpet composition includes one or more of turf fibers, primary backing material, secondary backing material, and/or a backing pad. For example, the turf feed includes a sized carpet composition and a second infill material of inorganic filler in an amount of about 50% or less by weight of the turf feed. In some embodiments, the turf feed includes sized turf fibers, a sized primary backing material, a sized secondary backing material, and an infill material, wherein the infill material is present in the turf feed in an amount of about 20% or less by weight of the turf feed.

In some embodiments, the turf feed includes a first infill material of an inorganic filler and a second infill of a polymeric material, wherein the first infill material is present in the turf feed in an amount of about 30% of less by weight of the turf feed. In some embodiments, the turf feed further includes at least one of sized turf fibers, sized primary backing material, or sized secondary backing material.

As previously described, one or more components of the artificial turf may be sized to reduce a median particle size for cracking. In some embodiments, the turf feed has a median particle size of 0.01 mm to 50 mm, 0.1 to 50 mm, 0.1 to 30 mm, 0.1 to 20 mm, 5.0 mm, or 0.1 mm to 5.0 mm, or 0.01 mm to 3.0 mm, or 0.1 mm to 3.0 mm, or 0.01 mm to 3.0 mm, or 0.1 mm to 3.0 mm, or 1.0 mm to 5.0 mm, or 1.0 mm to 3.0 mm. to reduce the maximum particle size. In some embodiments, turf feed has a maximum particle size of 20 mm or less, 10 mm or less, or 5.0 mm or less.

Optionally, a carrier fluid can also be included in the turf feed to assist with introducing the turf into the cracking environment. For introduction into a cracking environment, it can be convenient for the feedstock to be in the form of a slurry. If a carrier fluid is used for transporting the turf feed, any suitable fluid can be used. Examples of suitable carrier fluids can include (but are not limited to) a wide range of petroleum or petrochemical products. For example, some suitable carrier fluids include crude oil, naphtha, kerosene, diesel, light or heavy cycle oils, catalytic slurry oil, and gas-oils. Other potential carrier fluids can correspond to naphthenic and/or aromatics solvents, such as toluene, benzene, methylnaphthalene, cyclohexane, methylcyclohexane, and mineral oil. Still other carrier fluids can correspond to refinery fractions, such as a gas oil fraction or naphtha fraction from a coker. As yet another example, a distillate and/or gas oil boiling range fraction can be used that generated by cracking of the turf feed, either alone or with an additional feedstock.

In various embodiments, cracking can be used to co-process a combined feedstock corresponding to a mixture of a conventional cracking feedstock and a turf feed. In some embodiments, the conventional cracking feedstock is used as the carrier fluid for the turf feed. The conventional cracking feedstock can correspond to one or more types of petroleum and/or renewable feeds with a suitable boiling range for cracking, such as processing in a coker. The amount of turf feed in the combined feedstock can correspond to 0.1% to 25%, or 3% to 25%, or 10% to 25%, or 3% to 15% by weight of the combined feedstock. The conventional cracking feedstock can correspond to 70% to 99% by weight of the combined feedstock to the coker.

In some embodiments, the cracking feedstock for co-processing with the turf feed can correspond to a conventional petroleum feedstock having a relatively high boiling fraction, such as a heavy oil feed. For example, the cracking feedstock portion of the feed can have a T10 distillation point of 343° C. or more, or 371° C. or more. In some embodiments, the cooker feedstock has a T10 distillation point of 343° C. to 650° C. Examples of suitable heavy oils for inclusion in the cracking feedstock include, but are not limited to, reduced petroleum crude; petroleum atmospheric distillation bottoms; petroleum vacuum distillation bottoms, or residuum; pitch; asphalt; bitumen; other heavy hydrocarbon residues; tar sand oil; shale oil; or even a coal slurry or coal liquefaction product such as coal liquefaction bottoms. Such feeds will typically have a Conradson Carbon Residue (ASTM D189-165) of at least 5 wt %, generally from 5 wt % to 50 wt %. In some embodiments, the feed is a petroleum vacuum residuum.

Some examples of conventional petroleum feedstock suitable for processing in a delayed coker or fluidized bed coker can have a composition and properties within the ranges set forth below in Table 1.

TABLE 1
Example of Coker Feedstock

| | | |
|---|---|---|
| Conradson Carbon | 5 to 40 | wt % |
| API Gravity | −10 to 35° | |
| Boiling Point | 340° C.+ to | |
| | 650° C.+ | |
| Sulfur | 1.5 to 8 | wt % |
| Hydrogen | 9 to 11 | wt % |
| Nitrogen | 0.2 to 2 | wt % |
| Carbon | 80 to 86 | wt % |
| Metals | 1 to 2000 | wppm |

In addition to petroleum feedstocks, renewable feedstocks derived from biomass having a suitable boiling range can also be used as part of the cracking feed. Such renewable feedstocks include feedstocks with a T10 boiling point of 340° C. or more and a T90 boiling point of 600° C. or less. An example of a suitable renewable feedstock derived from biomass can be a cracking oil feedstock derived at least in part from biomass.

In some particular embodiments, the turf feed and the cracking feedstock (e.g., coker feedstock) are mixed to form a combined feedstock prior to entering the cracking environment. More generally, however, any convenient method for introducing both the turf feed and the cracking feedstock into the coking environment can be used.

Prior to being introduced into the coking environment, the feedstocks (optionally in the form of a combined feedstock) are pre-heated in accordance with one or more embodiments. Pre-heating the feedstocks in one or more heating stages can increase the temperature of the feedstocks to a mixing and storage temperature, to a temperature related to the cracking temperature, or to another convenient temperature.

In some embodiments, a portion of the pre-heating of a turf feed can be performed by mixing the turf feed with a cracking feedstock in a mixing tank and heating the mixture in the mixing tank. For example, a turf feed and a cracking feedstock can be mixed in a heated stirred tank for storage operating at 200° C. to 325° C., or 275° C. to 325° C. In some embodiments, tank agitation aids in uniform dispersal of the turf feed into resid and maintains slurry suspension. Heating in a mixing tank provides heat to the combined feedstock prior to introducing the combined feedstock into the cracking reaction environment. This can reduce or minimize additional cracking heat duty that would otherwise be required to heat the turf feed to thermal cracking temperatures. In addition to heating, stripping of the combined turf feed and cracking feedstock using a stripping gas can be performed in a mixing tank. Passing a stripping gas through the combined feedstock can assist with removing gases that are entrained in the combined feedstock.

Still another option can be to mix the turf feed with the cracking feedstock after the pre-heater furnace for the coker, in accordance with certain embodiments. In these embodiments, the cracking feedstock can be heated to a higher temperature in the pre-heater, and then the turf feed can be added to the pre-heated cracking feedstock to heat the turf feed.

### Artificial Turf Cracking

In accordance with one or more embodiments, the turf feed is cracked to producer more valuable cracking products. Cracking is a process in which larger molecules are broken down to produce smaller, more useful molecules. For example, cracking processes include thermally cracking long chain hydrocarbons (or other long chain molecules) into shorter chain molecules. Examples of suitable cracking processes include coking, steam cracking, fluid catalytic cracking, and/or pyrolysis.

One example of cracking for the turf feed includes coking. Coking generally involves thermal cracking of longer chain molecules to produce shorter chain molecules with excess carbon left behind in the form of petroleum coke. Where the turf feed includes inorganic filler, the inorganic filler should be segregated into the petroleum coke. Coking processes in modern refinery settings can typically be categorized as delayed coking or fluidized bed coking. Fluidized bed coking is a petroleum refining process in which heavy petroleum feeds, typically the non-distillable residues (resids) from the fractionation of heavy oils are converted to lighter, more useful products by thermal decomposition (coking) at elevated reaction temperatures, typically 480° C. to 590° C., and in most cases from 500° C. to 550° C. Example heavy oils suitable for processing by the fluid coking process include heavy atmospheric resids, petroleum vacuum distillation bottoms, aromatic extracts, asphalts, and bitumens from tar sands, tar pits and pitch lakes.

The Flexicoking™ process, developed by Exxon Research and Engineering Company, is a type of fluid coking process that is operated in a unit including a reactor and a heater, but also including a gasifier for gasifying the coke product by reaction with an air/steam mixture to form a low heating value fuel gas. A stream of coke passes from the heater to the gasifier where all but a small fraction of the coke is gasified to a low-BTU gas (˜120 BTU/standard cubic feet) by the addition of steam and air in a fluidized bed in an oxygen-deficient environment to form fuel gas including carbon monoxide and hydrogen. In a conventional Flexicoking™ configuration, the fuel gas product from the gasifier, containing entrained coke particles, is returned to the heater to provide most of the heat required for thermal cracking in the reactor with the balance of the reactor heat requirement supplied by combustion in the heater. A small amount of net coke (1 percent of feed) is withdrawn from the heater to purge the system of metals and ash. The liquid yield and properties are comparable to those from fluid coking. The fuel gas product is withdrawn from the heater following separation in internal cyclones which return coke particles through their diplegs.

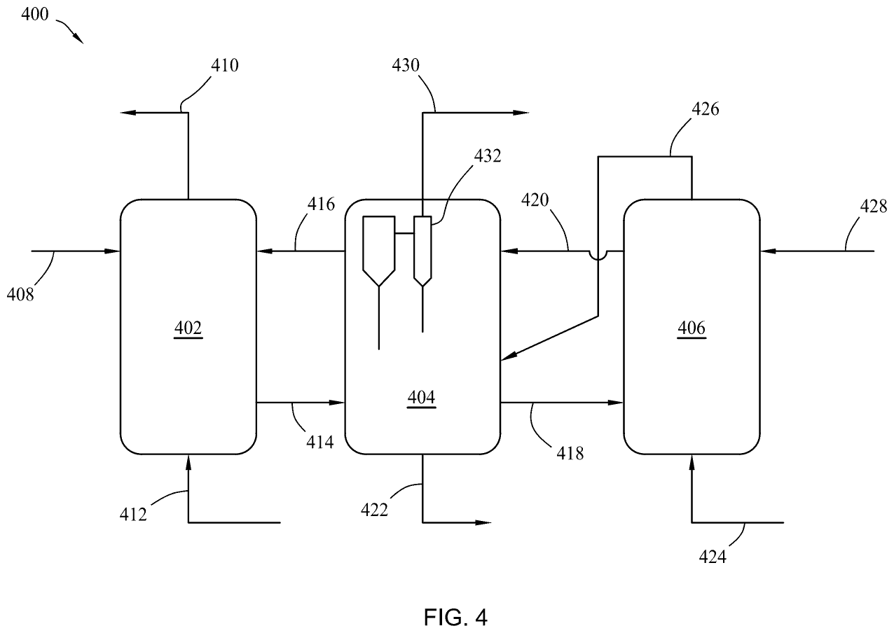

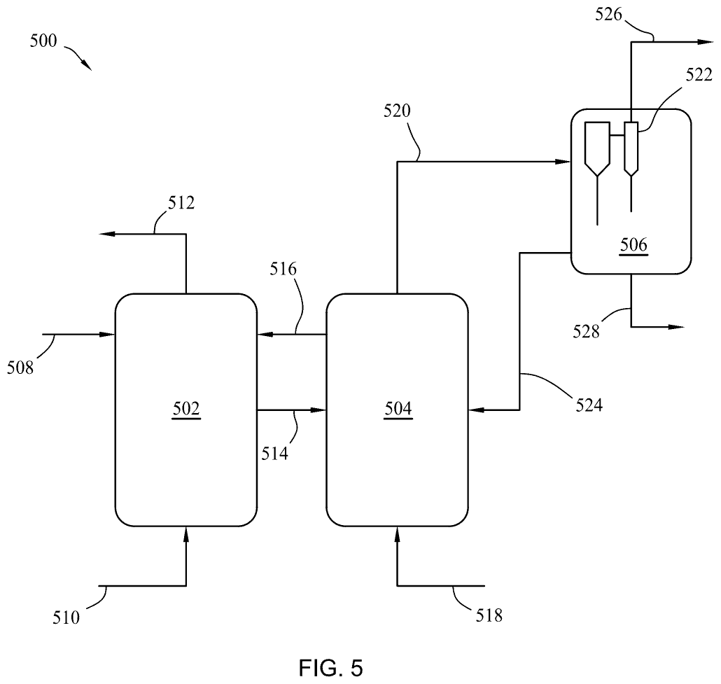

In this description, the term “Flexicoking” (trademark of ExxonMobil Research and Engineering Company) is used to designate a fluid coking process in which heavy petroleum feeds are subjected to thermal cracking in a fluidized bed of heated solid particles to produce hydrocarbons of lower molecular weight and boiling point along with coke as a by-product which is deposited on the solid particles in the fluidized bed. References to fluidized cokers are intended to include conventional fluidized cokers as well as flexicokers. The resulting coke can then be converted to a fuel gas by contact at elevated temperature with steam and an oxygen-containing gas in a gasification reactor (gasifier). This type of configuration can more generally be referred to as an integration of fluidized bed coking with gasification. FIGS. 4 and 5 provide examples of fluidized coking reactors that include a gasifier.

FIG. 4 shows an example of a Flexicoker unit (i.e., a system including a gasifier that is thermally integrated with a fluidized bed coker) with three reaction vessels: reactor, heater and gasifier. The coking system 400 includes reactor section 402 with the coking zone and its associated stripping and scrubbing sections (not separately indicated), heater 404 and gasifier 406. A cracking feedstock, which may be a turf feed (or combined feedstock of turf feed and conventional cracking feedstock) is introduced into the coking system 400 by line 408 and cracked hydrocarbon product withdrawn through line 410. While FIG. 4, shows a combined feedstock, example embodiments also include separate introduction of the conventional cracking feedstock and turf feed to the reactor section 402. Fluidizing and stripping steam is supplied by line 412. Cold coke is taken out from the stripping section at the base of reactor section 402 by means of line 414 and passed to heater 404. The term “cold” as applied to the temperature of the withdrawn coke is, of course, decidedly relative since it is well above ambient at the operating temperature of the stripping section. Hot coke is circulated from heater 404 to reactor section 402 through line 416. Coke from heater 404 is transferred to gasifier 406 through line 418 and hot, partly gasified particles of coke are circulated from the gasifier back to the heater 404 through line 420. The excess coke is withdrawn from the heater 404 by way of line 422. In conventional configurations, gasifier 406 is provided with its supply of steam and air by line 424 and hot fuel gas is taken from the gasifier 406 to the heater 404 though line 426. In some alternative embodiments, instead of supplying air via a line 424 to the gasifier 406, a stream of oxygen with 95 vol % purity or more can be provided, such as an oxygen stream from an air separation unit. In such embodiments, in addition to supplying a stream of oxygen, a stream of an additional diluent gas can be supplied by line 428. The additional diluent gas can correspond to, for example, CO₂ separated from the fuel gas generated during the gasification. The fuel gas is taken out from the unit through line 430 on the heater 404; coke fines are removed from the fuel gas in heater cyclone system 432 including serially connected primary and secondary cyclones with diplegs which return the separated fines to the fluid bed in the heater 404. The fuel gas from line 430 can then undergo further processing. For example, in some embodiments, the fuel gas from line 430 can be passed into a separation stage for separation of CO₂ (and/or H₂S). This can result in a stream with an increased concentration of synthesis gas, which can then be passed into a conversion stage for conversion of synthesis gas to methanol.

It is noted that in some optional embodiments, heater cyclone system 432 can be located in a separate vessel (not shown) rather than in heater 404. In such aspects, line 430 can withdraw the fuel gas from the separate vessel, and the line 422 for purging excess coke can correspond to a line transporting coke fines away from the separate vessel. These coke fines and/or other partially gasified coke particles that are vented from the heater 404 (or the gasifier 406) can have an increased content of metals relative to the feedstock. For example, the weight percentage of metals in the coke particles vented from the system (relative to the weight of the vented particles) can be greater than the weight percent of metals in the feedstock (relative to the weight of the feedstock). In other words, the metals from the feedstock are concentrated in the vented coke particles. Since the gasifier conditions do not create slag, the vented coke particles correspond to the mechanism for removal of metals from the coker/gasifier environment. In some embodiments, the metals can correspond to a combination of nickel, vanadium, and/or iron. Additionally, or alternately, the gasifier conditions can cause substantially no deposition of metal oxides on the interior walls of the gasifier, such as deposition of less than 0.10% by weight of the metals present in the feedstock introduced into the coker/gasifier system, or less than 0.010% by weight.

In configurations such as FIG. 4, the system elements shown in the figure can be characterized based on fluid communication between the elements. For example, reactor section 402 is in direct fluid communication with heater 404. Reactor section 402 is also in indirect fluid communication with gasifier 406 via heater 404.

As an alternative, integration of a fluidized bed coker with a gasifier can also be accomplished without the use of an intermediate heater. In such alternative aspects, the cold coke from the reactor can be transferred directly to the gasifier. This transfer, in almost all cases, will be unequivocally direct with one end of the tubular transfer line connected to the coke outlet of the reactor and its other end connected to the coke inlet of the gasifier with no intervening reaction vessel, i.e., heater. The presence of devices other than the heater is not however to be excluded, e.g., inlets for lift gas etc. Similarly, while the hot, partly gasified coke particles from the gasifier are returned directly from the gasifier to the reactor this signifies only that there is to be no intervening heater as in the conventional three-vessel Flexicoker™ but that other devices may be present between the gasifier and the reactor, e.g., gas lift inlets and outlets.

FIG. 5 shows an example of integration of a fluidized bed coker with a gasifier but without a separate heater vessel. In the configuration shown in FIG. 5, the cyclones for separating fuel gas from catalyst fines are located in a separate vessel. In other aspects, the cyclones can be included in a main gasifier vessel 504.

In the configuration shown in FIG. 5, the coker system 500 includes a reactor 502, main gasifier vessel 504 and a separator vessel 506. The cracking feedstock combined feedstock of cracking feedstock (e.g., heavy oil feed) and turf feed is introduced into reactor 502 through line 508 and fluidizing/stripping gas through line 510; cracked hydrocarbon products are taken out through line 512. The cracking feedstocks includes a turf feed with optional combination with a conventional cracking feedstock. The turf fed can be separately introduced to the reactor 502 or introduced in combination with a conventional cracking feedstock, for example. Cold, stripped coke is routed directly from reactor 502 to main gasifier vessel 504 by way of line 514 and hot coke returned to the reactor in line 516. Steam and oxygen are supplied through line 518. The flow of gas containing coke fines is routed to separator vessel 506 through line 520 which is connected to a gas outlet of the main gasifier vessel 504. The fines are separated from the gas flow in cyclone system 522 including serially connected primary and secondary cyclones with diplegs which return the separated fines to the separator vessel. The separated fines are then returned to the main gasifier vessel 504 through return line 524 and the fuel gas product taken out by way of line 526. Coke is purged from the separator through line 528. The fuel gas from line 526 can then undergo further processing for separation of CO₂ (and/or H₂S) and conversion of synthesis gas to methanol.

The coker and gasifier can be operated according to the parameters necessary for the required coking processes. Thus, the heavy oil feed in the cracking feedstock will typically be a heavy (high boiling) reduced petroleum crude; petroleum atmospheric distillation bottoms; petroleum vacuum distillation bottoms, or residuum; pitch; asphalt; bitumen; other heavy hydrocarbon residues; tar sand oil; shale oil; or even a coal slurry or coal liquefaction product such as coal liquefaction bottoms. Such feeds will typically have a Conradson Carbon Residue (ASTM D189-165) of at least 5 wt %, generally from 5 to 50 wt %. In some embodiments, the cracking feedstock is a petroleum vacuum residuum.

Fluidized coking is carried out in a unit with a large reactor containing hot coke particles which are maintained in the fluidized condition at the required reaction temperature with steam injected at the bottom of the vessel with the average direction of movement of the coke particles being downwards through the bed. In particular embodiments, the combined feedstock is heated to a pumpable temperature, typically in the range of 350° C. to 400° C., mixed with atomizing steam, and fed through multiple feed nozzles arranged at several successive levels in the reactor. Steam is injected into a stripping section at the bottom of the reactor and passes upwards through the coke particles descending through the dense phase of the fluid bed in the main part of the reactor above the stripping section. Part of the feed liquid coats the coke particles in the fluidized bed and is subsequently cracked into layers of solid coke and lighter products which evolve as gas or vaporized liquid. The residence time of the feed in the coking zone (where temperatures are suitable for thermal cracking) is on the order of 1 to 30 seconds. Reactor pressure is relatively low in order to favor vaporization of the hydrocarbon vapors which pass upwards from dense phase into dilute phase of the fluid bed in the coking zone and into cyclones at the top of the coking zone where most of the entrained solids are separated from the gas phase by centrifugal force in one or more cyclones and returned to the dense fluidized bed by gravity through the cyclone diplegs. The mixture of steam and hydrocarbon vapors from the reactor is subsequently discharged from the cyclone gas outlets into a scrubber section in a plenum located above the coking zone and separated from it by a partition. It is quenched in the scrubber section by contact with liquid descending over sheds. A pump-around loop circulates condensed liquid to an external cooler and back to the top shed row of the scrubber section to provide cooling for the quench and condensation of the heaviest fraction of the liquid product. This heavy fraction is typically recycled to extinction by feeding back to the coking zone in the reactor.

During a fluidized coking process, the combined feedstock, pre-heated to a temperature at which it is flowable and pumpable, is introduced into the coking reactor towards the top of the reactor vessel through injection nozzles which are constructed to produce a spray of the feed into the bed of fluidized coke particles in the vessel. Temperatures in the coking zone of the reactor are typically in the range of 450° C. to 650° C. and pressures are kept at a relatively low level, typically in the range of 0 kPag to 700 kPag, and most usually from 35 kPag to 320 kPag, in order to facilitate fast drying of the coke particles, preventing the formation of sticky, adherent high molecular weight hydrocarbon deposits on the particles which could lead to reactor fouling. In some embodiments, the temperature in the coking zone can be 450° C. to 600° C., or 450° C. to 550° C. The conditions can be selected so that a desired amount of conversion of the feedstock occurs in the fluidized bed reactor. For example, the conditions can be selected to achieve at least 10 wt % conversion relative to 343° C. (or 371° C.), or at least 20 wt % conversion relative 343° C. (or 371° C.), or at least 40 wt % conversion relative to 343° C. (or 371° C.), such as up to 80 wt % conversion or possibly still higher. The light hydrocarbon products of the coking (thermal cracking) reactions vaporize, mix with the fluidizing steam and pass upwardly through the dense phase of the fluidized bed into a dilute phase zone above the dense fluidized bed of coke particles. This mixture of vaporized hydrocarbon products formed in the coking reactions flows upwardly through the dilute phase with the steam at superficial velocities of roughly 1 to 2 meters per second (˜3 to 6 feet per second), entraining some fine solid particles of coke which are separated from the cracking vapors in the reactor cyclones as described above. In embodiments where steam is used as the fluidizing agent, the weight of steam introduced into the reactor can be selected relative to the weight of feedstock introduced into the reactor. For example, the mass flow rate of steam into the reactor can correspond to 6.0% of the mass flow rate of feedstock, or 8.0% or more, such as up to 10% or possibly still higher. The amount of steam can potentially be reduced if an activated light hydrocarbon stream is used as part of the stripping and/or fluidizing gas in the reactor. In such embodiments, the mass flow rate of steam can correspond to 6.0% of the mass flow rate of feedstock or less, or 5.0% or less, or 4.0% or less, or 3.0% or less. Optionally, in some embodiments, the mass flow rate of steam can be still lower, such as corresponding to 1.0% of the mass flow rate of feedstock or less, or 0.8% or less, or 0.6% or less, such as down to substantially all of the steam being replaced by the activated light hydrocarbon stream. The cracked hydrocarbon vapors pass out of the cyclones into the scrubbing section of the reactor and then to product fractionation and recovery.

In a general fluidized coking process, the coke particles formed in the coking zone pass downwards in the reactor and leave the bottom of the reactor vessel through a stripper section where they are exposed to steam in order to remove occluded hydrocarbons. The solid coke from the reactor, consisting mainly of carbon with lesser amounts of hydrogen, sulfur, nitrogen, and traces of vanadium, nickel, iron, and other elements derived from the feed, passes through the stripper and out of the reactor vessel to a burner or heater where it is partly burned in a fluidized bed with air to raise its temperature from 480° C. to 700° C. to supply the heat required for the endothermic coking reactions, after which a portion of the hot coke particles is recirculated to the fluidized bed reaction zone to transfer the heat to the reactor and to act as nuclei for the coke formation. The balance is withdrawn as coke product. The net coke yield is only 65 percent of that produced by delayed coking.

For a coking process that includes a gasification zone, the cracking process proceeds in the reactor, the coke particles pass downwardly through the coking zone, through the stripping zone, where occluded hydrocarbons are stripped off by the ascending current of fluidizing gas (steam). They then exit the coking reactor and pass to the gasification reactor (gasifier) which contains a fluidized bed of solid particles, and which operates at a temperature higher than that of the reactor coking zone. In the gasifier, the coke particles are converted by reaction at the elevated temperature with steam and an oxygen-containing gas into a fuel gas including carbon monoxide and hydrogen.

The gasification zone is typically maintained at a high temperature ranging from 850° C. to 1,000° C. and a pressure ranging from 0 kPag to 1000 kPag, preferably from 200 kPag to 400 kPag. Steam and an oxygen-containing gas are introduced to provide fluidization and an oxygen source for gasification. In some embodiments, the oxygen-containing gas can be air. In other embodiments, the oxygen-containing gas can have a low nitrogen content, such as oxygen from an air separation unit or another oxygen stream including 95 vol % or more of oxygen, or 98 vol % or more, are passed into the gasifier for reaction with the solid particles including coke deposited on them in the coking zone. In embodiments where the oxygen-containing gas has a low nitrogen content, a separate diluent stream, such as a recycled CO₂ or H₂S stream derived from the fuel gas produced by the gasifier, can also be passed into the gasifier.

In the gasification zone the reaction between the coke and the steam and the oxygen-containing gas produces a hydrogen and carbon monoxide-containing fuel gas and a partially gasified residual coke product. Conditions in the gasifier are selected accordingly to generate these products. Steam and oxygen rates (as well as any optional CO₂ rates) will depend upon the rate at which cold coke enters from the reactor and to a lesser extent upon the composition of the coke which, in turn will vary according to the composition of the heavy oil feed and the severity of the cracking conditions in the reactor with these being selected according to the feed and the range of liquid products which is required. In some embodiments, the fuel gas product from the gasifier contains entrained coke solids and these are removed by cyclones or other separation techniques in the gasifier section of the unit. Suitable cyclones include internal cyclones in the main gasifier vessel itself or external in a separate, smaller vessel as described below. The fuel gas product is taken out as overhead from the gasifier cyclones. The resulting partly gasified solids are removed from the gasifier and introduced directly into the coking zone of the coking reactor at a level in the dilute phase above the lower dense phase.

In some embodiments, the coking conditions can be selected to provide a desired amount of conversion relative to 343° C. Typically, a desired amount of conversion can correspond to 10 wt % or more, or 50 wt % or more, or 80 wt % or more, such as up to substantially complete conversion of the feedstock relative to 343° C.

The volatile products from the coke drum are conducted away from the process for further processing. For example, volatiles can be conducted to a coker fractionator for distillation and recovery of coker gases, coker naphtha, light gas oil, and heavy gas oil. Such fractions can be used, usually, but not always, following upgrading, in the blending of fuel and lubricating oil products such as motor gasoline, motor diesel oil, fuel oil, and lubricating oil. Upgrading can include separations, heteroatom removal via hydrotreating and non-hydrotreating processes, de-aromatization, solvent extraction, and the like. The process is compatible with processes where at least a portion of the heavy coker gas oil present in the product stream introduced into the coker fractionator is captured for recycle and combined with the fresh feed (coker feed component), thereby forming the coker heater or coker furnace charge. The combined feedstock ratio (“CFR”) is the volumetric ratio of furnace charge (fresh feed plus recycle oil) to fresh feed to the continuous fluidized coker operation. Fluidized coking operations typically employ recycles of 5 vol % to 35% vol % (CFRs of 1.05 to 1.35). In some embodiments, there can be no recycle and sometimes in special applications recycle can be up to 200%.

Delayed coking is another coking process for the thermal conversion of heavy oils such as petroleum residua (also referred to as “resid”) to produce liquid and vapor hydrocarbon products and coke. In particular embodiments, delayed coking is performed on a feedstock of a turf feed optionally combined with a conventional cracking feedstock to produce liquid and vapor hydrocarbon products and coke. In some embodiments, the conventional hydrocarbon feedstock includes resids from heavy and/or sour (high sulfur) crude oils. Delayed coking of the feedstock is carried out by converting part of the feedstock to more valuable hydrocarbon products. The resulting coke has value, depending on its grade, as a fuel (fuel grade coke), electrodes for aluminum manufacture (anode grade coke), etc.

Generally, a feedstock is pumped to a pre-heater where it is pre-heated, such as to a temperature from 480° C. to 520° C. The pre-heated feed is conducted to a coking zone, typically a vertically oriented, insulated coker vessel, e.g., drum, through an inlet at the base of the drum. Pressure in the drum is usually relatively low, such as 100 kPa-g to 550 kPa-g, or 100 kPa-g to 240 kPa-g to allow volatiles to be removed overhead. Typical operating temperatures of the drum will be between roughly 400° C. to 445° C., but can be as high as 475° C. The hot feed thermally cracks over a period of time (the “coking time”) in the coke drum, liberating volatiles composed primarily of hydrocarbon products that continuously rise through the coke bed, which consists of channels, pores and pathways, and are collected overhead. The volatile products are conducted to a coker fractionator for distillation and recovery of coker gases, gasoline boiling range material such as coker naphtha, light gas oil, and heavy gas oil. In an embodiment, a portion of the heavy coker gas oil present in the product stream introduced into the coker fractionator can be captured for recycle and combined with the fresh feed (coker feed component), thereby forming the coker heater or coker furnace charge. In addition to the volatile products, the process also results in the accumulation of coke in the drum. When the coke drum is full of coke, the heated feed is switched to another drum and hydrocarbon vapors are purged from the coke drum with steam. The drum is then quenched with water to lower the temperature down to 95° C. to 150° C., after which the water is drained. When the draining step is complete, the drum is opened, and the coke is removed by drilling and/or cutting using high velocity water jets (“hydraulic decoking”).

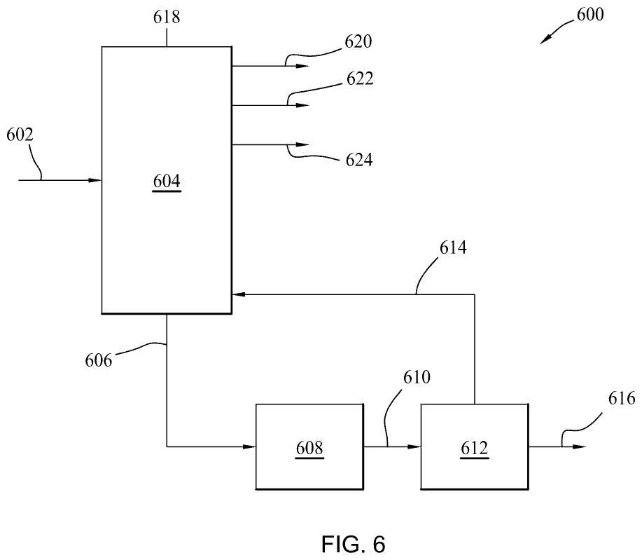

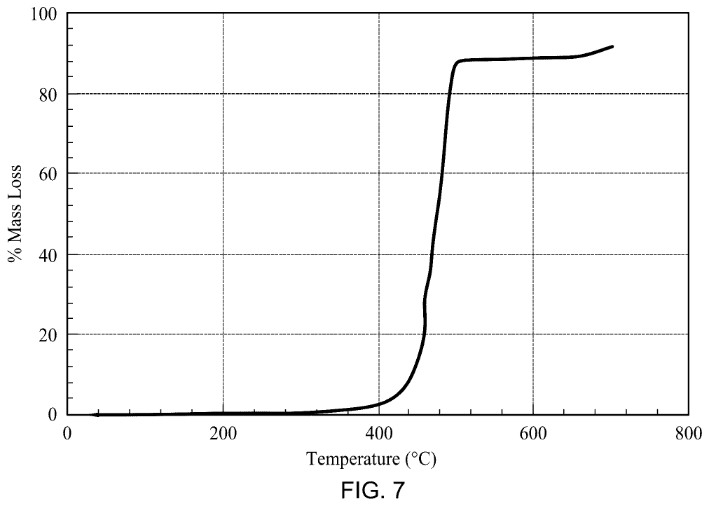

FIG. 6 illustrates an example delayed coking system 600. In the illustrated embodiment, a feedstock 602 including a turf feed, which may be preheated, is fed into a coker fractionator 604. In some embodiments, the feedstock 602 further includes a conventional cracking feedstock, which may also be separately feed to the coker fractionator 604. In the illustrated embodiment, a fractionator effluent 606 including at least a portion of the turf feed and/or conventional cracking feedstock is withdrawn from the coker fractionator 604 and fed to a coker furnace 608. From the coker furnace 608, the preheated effluent 610 including a preheated turf feed and/or preheated conventional cracking feedstock is passed to a coking zone 612, which includes, for example, a coking vessel or coking drum. The preheated effluent 610 also includes, for example, tower bottoms (or recycle). The coking zone 612 is operated at coking conditions such that the preheated turf feed/conventional cracking feedstock thermally cracks over a period of time (the “coking time”) in the coke zone, liberating volatiles composed primarily of hydrocarbon products that continuously rise through the coke bed, which consists of channels, pores and pathways, and are collected overhead as a coker effluent 614, which is passed to the coker fractionator 604. In the illustrated embodiment, the coker effluent 614 is separated in the coker fractionator 604 into various fractions, including, but not limited to, one or more of a coker gas fraction 618, a coker naphtha fraction 620, a coker distillate fraction 622, and a coker gas oil fraction 624. As previously mentioned, coke is accumulated in the coking zone 612 (e.g., coking vessel). The coke further includes inorganic filler from the turf feed. A coke product 616 including coke and inorganic filler is withdrawn from the coking zone 612.

### Cracking Products

Cracking of the turf feed either alone or in combination with the conventional cracking feedstock produces cracking products. In some embodiments, the cracking products include a cracking effluent, which may include a gas, a liquid, or a mixture thereof. As discussed above, the cracking effluent can be fractionated or otherwise separated to form desirable product streams, such as fuel gas (e.g., C₄ and lighter hydrocarbons), naphtha, diesel, gasoline, light cycle oil, and/or heavy cycle oil. In some embodiments, the cracking products further include coke.

Coke produced in a coking process is typically a carbonaceous solid material of which a majority is carbon. Since the coke is produced from petroleum cracking process of a conventional cracking feedstock in the coker, it can also be referred to as petroleum coke or petcoke, in accordance with one or more embodiments. The particular composition of the coke depends on a number of factors, including the particular coking process, such as a delayed coker or in some embodiments, the coke includes carbon in an amount of 80 wt % to 95 wt % based on a total weight of the coke. Additional components in the coke include hydrogen, nitrogen, sulphur, and heavy metals, such as aluminum, boron, calcium, chromium cobalt, iron, manganese, magnesium, molybdenum, nickel, potassium, silicon, sodium, titanium, and/or vanadium.

In some embodiments, the coke produced originates at least in part from turf feed, which can include an inorganic filler. Examples of suitable inorganic fillers, include sand and gravel. In these embodiments, the inorganic fillers are diverted into the coke, resulting in the coke including inorganic residues, such as oxides of silica or the like. For example, conventional coke can include oxides of silica in amounts up to 600 wppm. However, the coke produced at least in part from turf feed include oxides of silica in an amount 1000 wppm or more, in example embodiments. In some embodiments, the coke includes oxides of silica in an amount of 1000 wppm to 2 wt %, 1000 wppm to 1 wt %, 5000 wppm to 2 wt %, or 1 wt % to 2 wt %. However, while the fillers and reinforcing materials are present in amounts sufficient to expel enough from the process to achieve steady-state operation, the coke should meet specification for petroleum coke in accordance with one or more embodiments.

In some embodiments, the cracker effluent originates at least in part from polymeric materials in the turf feed, such thermoplastic and thermoset resins. In some embodiments, the processing of the turf feed may result in the production or recovery of olefins, or the attribution of turf feed to olefins. In some embodiments, polymers may be produced from the olefins. For example, processing of the turf feed by cracking may directly produce or recover olefins used to make polymers. At least a portion of these olefins may be circular olefins that are attributable to the turf feed, such as determined by crediting, allocating, and/or offsetting or substituting for other hydrocarbons in a mass or energy balance for a system, such as in accordance with a third-party certification relating to circularity. At least a portion of these chemical products may be certified circular chemical products that are certified for their circularity by third party certification may be referred to as certified circular. One example of such a certification is the mass balance chain of custody method set forth by the International Sustainability and Carbon Certification.

### Additional Embodiments

Accordingly, the present disclosure may provide for the chemical recycling of artificial turf that includes cracking a turf feed to produce hydrocarbons. The methods and systems may include any of the various features disclosed herein, including one or more of the following statements.

Embodiment 1. A method of chemical recycling artificial turf, comprising: providing a turf feed comprising a sized turf composition; and cracking at least the turf feed to produce at least a cracking product comprising hydrocarbons.

Embodiment 2. The method of Embodiment 1, wherein the turf feed further comprises an inorganic filler from the artificial turf in an amount of about 0.1% to about 50% by weight of the turf feed.

Embodiment 3. The method of Embodiment 1, wherein the first infill material is present in the turf feed in an amount of about 0.1% to about 5% by weight of the turf feed.

Embodiment 4. The method of any preceding Embodiment, wherein the turf feed further comprises an infill material from the artificial turf, wherein the second infill material comprises a polymeric material.

Embodiment 5. The method of any preceding Embodiment, wherein the sized carpet composition comprises turf fibers.

Embodiment 6. The method of Embodiment 5, wherein the turf fibers have a median particle size of 0.1 millimeters to 5 millimeters.

Embodiment 7. The method of Embodiment 5 or Embodiment 6, wherein the turf fibers comprise a thermoplastic material.

Embodiment 8. The method of any preceding Embodiment, wherein the sized carpet composition comprises turf fibers, a primary backing material, and a secondary backing material.

Embodiment 9. The method of any preceding Embodiment, further sizing the artificial turf to reduce particle size, wherein sized artificial turf is used as the sized carpet composition in the turf feed without further separation.

Embodiment 10. The method of any one of Embodiments 1 to 8, further comprising sizing the artificial turf to reduce particle size and then separating at least a portion of the infill material from the artificial turf to form the carpet composition, wherein the carpet composition comprises turf fibers, a primary backing material, and a secondary backing material.

Embodiment 11. The method of any one of Embodiments 1 to 8, further comprising sizing the artificial turf to reduce particle size then separating infill material from the sized artificial turf, then performing a second sizing step on the sized artificial turf after the separating, then separating additional infill material from the sized artificial turf to obtain the carpet composition.

Embodiment 12. The method of any preceding Embodiment, further comprising separating at least a naphtha fraction and a gas fraction from the cracking product.

Embodiment 13. The method of any preceding Embodiment, wherein the cracking comprises exposing at least a portion of a coker feedstock comprising the turf feed to coking conditions in a coking reactor, wherein the coking conditions comprise exposing the coker feedstock to a fluidized bed of coke particles at a temperature of about 450° C. to about 650° C.

Embodiment 14. The method of Embodiment 13, wherein the coker feedstock comprises a petroleum feedstock with a T10 distillation point of about 343° C. to about 650° C.

Embodiment 15. The method of any preceding Embodiment, wherein the cracking further produces a coke product, wherein the coke product comprises coke and recovered infill material, wherein at least 99% by weight of an inorganic filler in the turf feed from the artificial turf is recovered in the coke product as the recovered infill material.

Embodiment 16. The method of any preceding Embodiment, wherein the cracking at least the turf feed comprises preheating a coker feedstock comprising the turf feed and a petroleum feedstock, feeding the coker feedstock into a coking zone in a coker drum, wherein the coker feedstock thermally cracks.

Embodiment 17. The method of any preceding Embodiment, wherein the cracking product comprises olefins.

Embodiment 18. The method of Embodiment 17, further comprising producing at least circular polyolefins from the olefins.

Embodiment 19. A method of chemical recycling artificial turf, comprising: providing a turf feed comprising an infill material from the artificial turf, wherein the infill material comprises a polymeric material; and cracking the turf feed to produce at least a cracking product comprising hydrocarbons.

Embodiment 20. The method of Embodiment 18, wherein the turf feed further comprises an inorganic filler from the artificial turf, wherein the inorganic filler is present in the turf feed in an amount of about 0.1% to about 50% by weight of the turf feed.

Embodiment 21. The method of Embodiment 18, wherein the turf feed further comprises an inorganic filler from the artificial turf, wherein the inorganic filler is present in the turf feed in an amount of about 1% to about 5% by weight of the turf feed.

Embodiment 22. The method of any one of Embodiments 19 to 21, further comprising sizing the artificial turf to reduce particle size then separating the infill material from the sized artificial turf.

Embodiment 23. The method of any one of Embodiments 19 to 22, wherein the cracking further produces a coke product, wherein the coke product comprises coke and recovered infill material, wherein at least 99% by weight of an inorganic filler in the turf feed from the artificial turf is recovered in the coke product as the recovered infill material.

Embodiment 24. The method of any one of Embodiments 19 to 23, wherein the polymeric material comprises a thermoplastic elastomer.

Embodiment 25. The method of any one of Embodiments 19 to 23, wherein the polymeric material comprises ground tire rubber.

Embodiment 26. The method of any one of Embodiments 19 to 23, wherein the polymeric material comprises thermoset rubber.

To facilitate a better understanding of the present invention, the following examples of certain aspects of some embodiments are given. In no way should the following examples be read to limit, or define, the entire scope of the disclosure.

### Example 1

Various artificial turf samples were obtained from end-of-life sports fields using the recovery methods described herein. The primary and secondary infill materials were separated from the turf samples to provide carpet compositions. The secondary infill material (rubber) was subsequently separated from the primary infill (sand).

Table 2 below shows the chemical compositions for the various turf samples. Sample 1 is the separated carpet composition from a first artificial turf. Sample 2 is the separated secondary infill material from the first artificial turf Sample 3 is the separated carpet composition in pellet form from a second artificial turf. Sample 4 is the separated carpet composition in pellet form for a third artificial turf. The separated carpet composition for Sample 4 was extruded into pellets. Sample 5 is the separated carpet composition from a fourth artificial turf. Sample 5 was prepared by cutting the artificial turf then separating the carpet composition. The chemical compositions of the samples were determined by a number of different characterization techniques. For example, ash content was measured as per ASTM D5185 method using ICP-AES (Perkin Elmer 8300). Halides content (Cl, F) was measured using X-Ray Fluorescence technique (Malvern P analytical instrument). CHNOS analysis was performed as per ASTM D5291 method using combustion elemental analyzer. Mercury measurements were performed as per UOP938 method using CVAAS spectroscopy. Ti, Ca, Na, Fe analysis was performed using ICP.

TABLE 2

| | Ash | Cl | Ti | C | H | N | O |
|---|---|---|---|---|---|---|---|
| Sample | wt % | wppm | Wppm | wt % | wt % | wt % | wt % |
| 1 | 11.1 | 555 | 97 | 73.7 | 11.8 | 0.2 | 7.0 |
| 2 | 12.0 | | | 71.7 | 6.6 | 0.4 | 12.9 |
| 3 | 11.5 | 536 | 354 | 72.5 | 11.9 | 0.2 | 1.0 |
| 4 | 16.2 | 790 | 186 | 67.4 | 10.6 | 0.3 | 7.9 |
| 5 | 26.8 | 319 | 169 | No data | No data | No data | No data |

| | S | C + H | Ca | Fe | Na | Hg | F |
|---|---|---|---|---|---|---|---|
| Sample | wt % | wt % | wppm | wppm | wppm | wppm | wppm |
| 1 | 0.0 | 85 | 39,930 | 9,239 | 26 | 5.4 | 102 |
| 2 | 1.5 | 78 | 4,980 | 571 | 330 | 29.7 | 12 |
| 3 | 0.0 | 84 | 26,200 | 9,465 | 129 | 9.4 | |
| 4 | 0.0 | 78 | 75,840 | 4,022 | 139 | 1.6 | 32 |
| 5 | No data | No data | 72,490 | 4,715 | 132 | 12.3 | 51 |

A comparison of the chemical compositions for Samples 1 and 3-5 for the separated carpet composition and Sample 2 for separated secondary infill part shows that these can be pyrolyzed in any suitable combination, e.g., carpet composition/secondary infill from 0-100 wt %. The samples have high carbon and hydrogen levels, thermal cracking by cracking should yield desirable products for further processing. These hydrogen-to-carbon ratios are consistent with carpet compositions with polyolefin fibers and a general-purpose rubber for the secondary infill material. In addition, the samples have low chloride content, so a de-chlorination step is not required. The ash content is higher than 10 wt % in each sample. Thus, in chemical recycling, the inorganic filler will need to be removed from the process, for example, removed with the coke in a coking process, to prevent accumulation of the inert inorganic fillers in the process.

### Example 2

This example was performed to illustrate cracking of a turf feed on a laboratory scale. Thermogravimetric analysis (TGA) was used to analyze cracking of Sample 1 comprised of a separated carpet composition. This sample was pyrolyzed under inert nitrogen atmosphere in the TGA with controlled heating. The temperature was increased from room temperature to 700° C. with a thermal rate of 20° C./minute and then held at 700° C. for 1 hour. The mass loss profile from TGA is shown in FIG. 6. As illustrated in this figure, more than 88 wt % of the turf feed of Sample 1 was converted to volatiles at 530° C.

### Example 3

This example was performed to determine cracking product distribution of a turf feed on a laboratory scale. Approximately 0.5 milligrams of a turf feed of Sample 1 comprised of a separated carpet composition was loaded into a CDS 5150 micropyrolyzer and the temperature program was set to rapidly heat it to cracking temperatures relevant to coker operations. This resin sample was pyrolyzed at 530° C. for 20 seconds. The micropyrolyzer was coupled to the inlet of a GC/MS by a transfer line that was heated to 250° C. to avoid condensation. The evolved Cracking products were identified by the electron impact mass spectroscope. The main cracking products are provided in Table 3 below. The % Area represented in Table 3 represents relative concentration of products.

TABLE 3
Cracking Products - Artificial Turf Sample#1

| Compound | % Area |
|---|---|
| Ethylene | 2.1 |
| Propylene | 5.5 |
| 2-Butene | 4.2 |
| Pentane | 2.1 |
| 1-Hexene | 5.8 |
| 1-Heptene | 2.3 |
| 2,4-Dimethyl-1-Heptene | 6.0 |
| 1,3,5,7-Cycclooctatetraene | 2.0 |
| 1-Octene, 3,7-dimethyl- | 3.0 |
| 3-Undecene, (Z)- | 2.3 |
| 1-Docosene | 2.0 |

As shown in Table 3, cracking of the Sample 1 comprised of a separated carpet composition results in production of a variety monomers useful for further processing.

While the disclosure has been described with respect to a number of embodiments and examples, those skilled in the art, having benefit of this disclosure, will appreciate that other embodiments can be devised which do not depart from the scope and spirit of the disclosure as disclosed herein. Although individual embodiments are discussed, the present disclosure covers all combinations of all those embodiments.

While compositions, methods, and processes are described herein in terms of “comprising,” “containing,” “having,” or “including” various components or steps, the compositions and methods can also “consist essentially of” or “consist of” the various components and steps. The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the disclosure, additionally, they do not exclude impurities and variances normally associated with the elements and materials used.

All numerical values within the detailed description are modified by “about” the indicated value, and take into account experimental error and variations that would be expected by a person having ordinary skill in the art.

Many alterations, modifications, and variations will be apparent to those skilled in the art in light of the foregoing description without departing from the spirit or scope of the present disclosure and that when numerical lower limits and numerical upper limits are listed herein, ranges from any lower limit to any upper limit are contemplated.

1. A method of chemical recycling artificial turf, comprising:
providing a turf feed comprising a sized carpet composition; and
cracking at least the turf feed to produce at least a cracking product comprising hydrocarbons.

2. The method of claim 1, wherein the turf feed further comprises an infill material from the artificial turf, wherein the infill material comprises a polymeric material.

3. The method of claim 1, wherein the sized carpet composition comprises turf fibers, and wherein the turf fibers have a median particle size of 0.1 millimeters to 5 millimeters, optionally wherein the turf fibers comprise a thermoplastic material.

4. The method of claim 1, wherein the sized turf composition comprises turf fibers, a primary backing material, and a secondary backing material.

5. The method of claim 1, further comprises sizing the artificial turf to reduce particle size, wherein the sized artificial turf is used as the sized carpet composition in the turf feed without further separation.

6. The method of claim 1, further comprising sizing the artificial turf to reduce particle size and then separating at least a portion of the infill material from the artificial turf to form the carpet composition, wherein the carpet composition comprises turf fibers, a primary backing material, and a secondary backing material.

7. The method of claim 1, further comprising sizing the artificial turf to reduce particle size then separating infill material from the sized artificial turf, then performing a second sizing step on the sized artificial turf after the separating, then separating additional infill material from the sized artificial turf to obtain the carpet composition.

8. The method of claim 1, further comprising separating at least a naphtha fraction and a gas fraction from the cracking product.

9. The method of claim 1, wherein the cracking comprises exposing at least a portion of a coker feedstock comprising the turf feed to coking conditions in a coking reactor, wherein the coking conditions comprise exposing the coker feedstock to a fluidized bed of coke particles at a temperature of about 450° C. to about 650° C., wherein the coker feedstock comprises a petroleum feedstock with a T10 distillation point of about 343° C. to about 650° C.

10. The method of claim 1, wherein the cracking product comprises olefins, wherein the method further comprises producing at least circular polyolefins from the olefins.

11. A method of chemical recycling artificial turf, comprising:
providing a turf feed comprising an infill material from the artificial turf, wherein the infill material comprises a polymeric material; and
cracking the turf feed to produce at least a cracking product comprising hydrocarbons.

12. The method of claim 11, further comprising sizing the artificial turf to reduce particle size then separating the infill material from the sized artificial turf.

13. The method of claim 11, wherein the polymeric material comprises at least one of thermoplastic elastomer, ground tire rubber, or thermoset rubber.

14. The method of claim 11, wherein the turf feed further comprises an inorganic filler from the artificial turf, wherein the inorganic filler is present in the turf feed in an amount of about 0.1% to about 50% by weight of the turf feed.

15. The method of claim 11, wherein the cracking further produces a coke product, wherein the coke product comprises coke and recovered infill material, wherein at least 99% by weight of an inorganic filler in the turf feed from the artificial turf is recovered in the coke product as the recovered infill material.
